(19) United States
(12) Patent Application Publication
(10) Pub. No.: US 2008/0143639 A1
(43) Pub. Date: Jun. 19, 2008

(54) HELMET-MOUNTED DISPLAY SYSTEM WITH INTERCHANGEABLE OPTICAL MODULES

(75) Inventors: Jean-Pierre GERBE, Pessac (FR); Joel Baudou, Medard En Jalles (FR)

Correspondence Address: LOWE HAUPTMAN & BERNER, LLP, 1700 DIAGONAL ROAD, SUITE 300, ALEXANDRIA, VA, 22314, US

(73) Assignee: Thales, Neuilly-Sur-Seine (FR)

(21) Appl. No.: 11/776,307

(22) Filed: Jul. 11, 2007

(30) Foreign Application Priority Data
Jul. 11, 2006 (FR) 06 06306

(51) Int. Cl. G02B 27/01

(52) U.S. Cl. 345/8

(57) ABSTRACT

The field of the invention is that of helmet-mounted display systems having a support helmet intended to be worn by a user, and a display system. To make the system compatible with daytime and night-time applications, the device includes a single image generator supported by the helmet and two interchangeable optomechanical devices. The first optomechanical device is specifically dedicated to daytime applications and the second optomechical device is specifically dedicated to night-time applications. In a preferred embodiment, the night time device has night vision goggles, one of the bodies of which has in front of its objective, an image mixer system mounted on the image generator.

### RELATED APPLICATIONS

The present application is based on, and claims priority from, France Application Number 06 06306, filed Jul. 11, 2006, the disclosure of which is hereby incorporated by reference herein in its entirety.

### BACKGROUND OF THE INVENTION

1. Field of the Invention

The field of the invention is that of helmet-mounted display systems. These systems are essentially used in the aeronautical field for aircraft pilots.

2. Description of the Prior Art

In general, these systems mounted on the pilot's helmet comprise an image generator and an optical collimation assembly for superposing the generated image on the external scene in the visual field of the operator. By this means, the pilot is provided with information about the aircraft systems, especially the weapon, navigation or flight control systems. Thus, the pilot always has both the vision of the external scene and information useful about the flight or the aircraft without having to use information presented on displays or instruments on the instrument panel.

One of the difficulties with this type of system is that it must be able to be used both in the daytime and at night. Use at night requires the light from the external scene to be amplified before it is presented to the user.

In general, devices known by the acronym NVG (night vision goggles) are used. To solve this problem, two approaches are possible.

Two completely autonomous independent devices may be produced, the first optimized for daytime applications and the second for night-time applications. The main drawback of this arrangement is that it requires the use of two complete devices, thereby increasing the cost of the system.

It is also possible to produce a complete system incorporating both functions. However, this solution has several drawbacks:

the more numerous the optical functions to be produced, more difficult it becomes to meet the helmet-mounting constraints, especially the ergonomic constraints. This is because the overall helmet must still be of acceptable weight and the centre of gravity of the helmet must optimally correspond to the centre of gravity of the pilot's head. It is also necessary to take into account other devices mounted on the helmet, such as visors, helmet-mounted position detection or communication systems; and

in a device of this type, the video image must be mixed with the intensified image and then the combination of the two images mixed with the image of the external scene. The photometric balances are therefore in general not very satisfactory, bearing in mind that transmission of the external scene must remain high.

### SUMMARY OF THE INVENTION

The object of the invention is to propose a novel approach for producing a helmet-mounted display system capable of ensuring daytime display and night-time display. For this purpose, the display system comprises a support helmet and two interchangeable display modules, the first optimized for daytime applications and the second optimized for night-time applications. These two modules comprise specific optomechanical devices and a common image generator interchangeable from one module to the other. Thus, a good compromise is achieved between the performance of the system and its cost. This is because the image generator is common to daytime display and night-time display. In addition, only a single optomechanical assembly has to be stowed in the cockpit when it is not being used. Moreover, since this assembly has no wiring or electronic interface, it is therefore easier to stow.

More precisely, the subject of the invention is a modular helmet-mounted display assembly comprising at least:

a support helmet intended to be worn by a user;

an image generator intended to be mounted on said helmet;

a first optomechanical device comprising at least first collimation/superposition means for collimating the images output by the image generator and for superposing them on the external scene; and

a second optomechanical device comprising at least second collimation/superposition means for collimating the images output by the image generator and for superposing them on the external scene, and means for amplifying the external scene and said collimated images, characterized in that:

the image generator and the first and second optomechanical devices include complementary optomechanical coupling means either for fastening the image generator to the first optomechanical device, so as to produce a first display module, or for fastening the image generator to the second optomechanical device, so as to produce a second display module; and

the first and second modules also include mechanical coupling means for fastening said modules to the helmet and for disconnecting them therefrom.

Advantageously, the image generator includes at least one image display and an optical collimation device placed in front of this display and forming, from the image provided by this display, a collimated image, it being possible for the image generator to be placed on one of the lateral parts of the support helmet.

Advantageously, the first optomechanical device essentially consists of a transparent plate having substantially plane and mutually parallel faces, said plate comprising at least a reflecting first curved mirror and a semi-reflecting second curved mirror which are placed so as to obtain an afocal optical device.

Advantageously, the amplifying means of the second device comprise at least a first goggles body, said first body including essentially a focusing objective, an optoelectronic amplifier device and an eyepiece.

Finally, in a first embodiment, the second optical collimation/superposition means for collimating the images output by the image generator and for superposing them on the external scene may comprise:

an optical-fibre image transporter comprising an optical-fibre guide and two focusing optics placed at each end of the fibre guide; and

a semi-reflecting optic placed between the image transporter and the focusing objective of the first goggles body.

In a second embodiment, the second optical collimation/superposition means for collimating the images output by the image generator and for superposing them on the external scene essentially comprise a semi-reflecting optic placed between the image generator and the focusing objective of the first goggles body.

### BRIEF DESCRIPTION OF THE DRAWINGS

The invention will be better understood and other advantages will become apparent on reading the following description given by way of non-limiting example and in conjunction with the appended figures in which:

FIG. 1 shows an exploded view of a modular helmet-mounted display assembly according to the invention;

FIG. 2 shows a support helmet with a first, so-called daytime display module;

FIG. 3 shows the principle of operation of said first display module;

FIG. 4 shows the same support helmet with a first embodiment of the second, so-called night-time display module;

FIG. 5 shows the principle of operation of said display module of FIG. 4;

FIG. 6 shows the support helmet with a second embodiment of the so-called night-time display module; and

FIG. 7 shows the principle of operation of said second display module of FIG. 6.

### MORE DETAILED DESCRIPTION

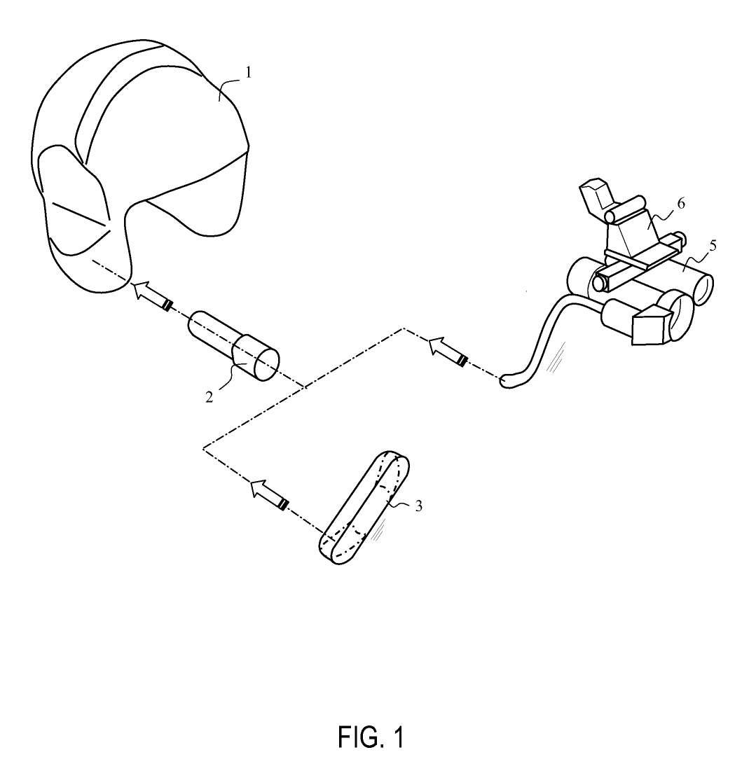

FIG. 1 shows an exploded view of a modular helmet-mounted display assembly according to the invention with its various elements. It essentially comprises:

a support helmet 1;

an image generator 2;

a first optomechanical device 3 comprising first optical means for collimating and superposing the images output by the image generator 2; and

a second optomechanical device 5 comprising second optical means for collimating and superposing the images output by the image generator 2, and means for amplifying the external scene and said collimated images.

In this view, a number of devices such as visors, helmet-mounted detection or communication systems have not been shown for the sake of clarity.

The image generator 2 may be permanently fixed to one of the lateral parts of the support helmet 1. This arrangement has several advantages:

it makes it easier to fit the collimation/superposition optic; and

it lowers the centre of gravity of the entire system.

Of course, other arrangements are possible. As an example, the image generator may be fastened to one of the optomechanical devices, the latter itself being fastened to the helmet by its own mechanical coupling means.

In all cases, the electrical wiring connecting the image generator to the electronic unit, for supplying power and for generating the electronic images, may be partly fastened to the helmet.

Advantageously, the generator comprises at least one image display 21 and an optical collimation device 22 placed in front of this display and forming, from the image provided by this display, a collimated image. This arrangement has several advantages:

it simplifies the collimation/superposition optic;

the collimation optic protects the display; and

it improves the mechanical tolerances of the coupling insofar as the final image will always be collimated, even if the coupling is not perfect. Conventionally, the display 21 is a cathode-ray tube. This type of display provides high-resolution high-luminance images. Of course, other types of display are possible, such as liquid-crystal displays or micromirror displays.

The display also includes optomechanical coupling means 23 for fastening it to the optomechanical devices so as to produce display modules. These means may for example be similar to mechanical devices (screw or bayonet systems) used for mounting photo-graphic lenses on cameras, and which are well known to those skilled in the art.

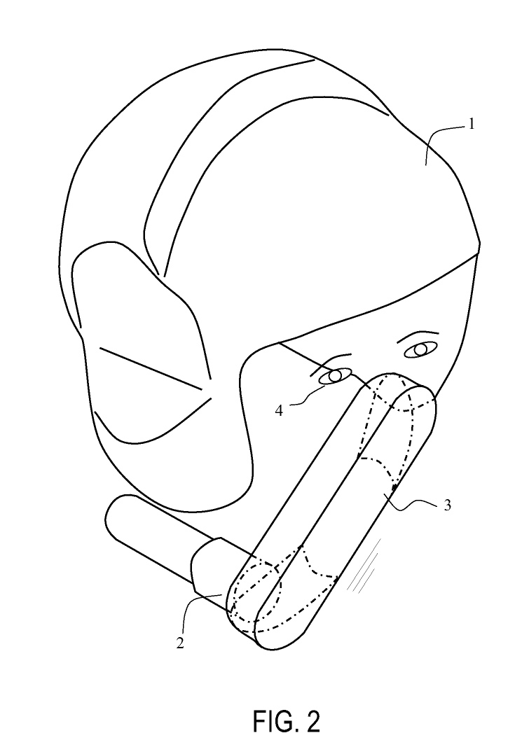

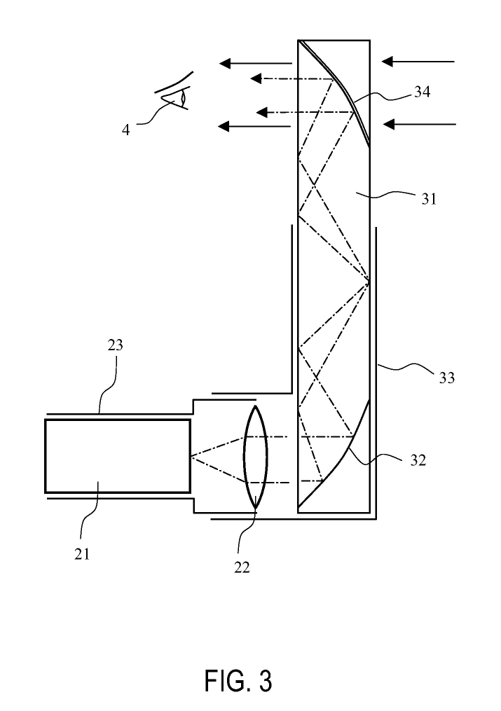

FIG. 2 shows the support helmet 1 with a first, so-called daytime display module. The optomechanical device 3 is fastened to the image generator 2 by mechanical coupling means (not shown in FIG. 2). It is simply necessary to ensure that the positioning tolerances are sufficient to provide a high-quality image suitably oriented in front of the observer's eye 4. The essential function of the optomechanical device 3 is to collimate the images output by the image generator 2 and superpose them on the external scene in the pilot's field of view. As a non-limiting example, FIG. 3 shows the principle of production of said first optomechanical device 3. This essentially comprises:

a transparent plate 31 having substantially plane and mutually parallel faces 35 and 36, said plate comprising at least a reflecting first curved mirror 32 and a semi-reflecting second curved mirror 34 which are placed so as to obtain an afocal optical device; and

a mechanical support 33, which includes the means for coupling it to the image generator. The path of the light rays coming from the image generator 2 is indicated by the dotted arrows in FIG. 3. The collimated rays coming from the optical collimation device 22 are focused by means of the curved mirror 32. The mirror 32 is generally a parabolic mirror so as to minimize the geometrical image aberrations. The inclination of this mirror is such that the light rays propagate by total reflection off the faces 35 and 36 within the transparent plate 31. A semi-reflecting second mirror 34, equivalent to the first mirror 32 and possibly also parabolic, is placed so that its focal plane coincides with that of the mirror 32. Thus, the focused rays coming from the mirror 32 are again collimated by reflection off this mirror 34. These rays are then transmitted by the plate 31 to the observer, where they are superposed with the light rays coming from the external scene that have passed through the plate 31 without suffering any distortion.

This two-mirror arrangement makes it possible not only to transport the image output by the generator but also the pupil of the optomechanical device. Thus, it is possible by this arrangement to form an image of the pupil of the system close to the user's eye.

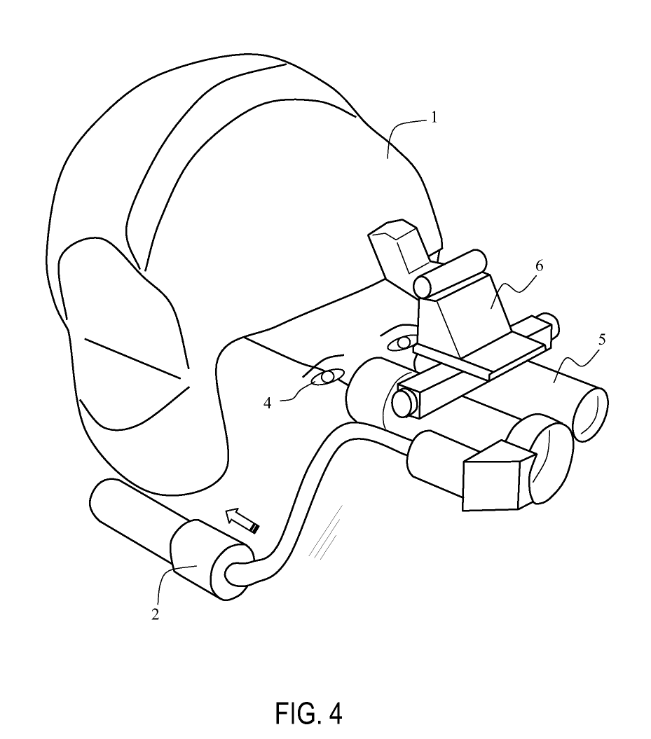

FIG. 4 shows the same support helmet with a first embodiment of a second, so-called night-time display module. The optomechanical device 5 is fastened to the image generator by mechanical coupling means (not shown in this figure). In FIG. 4, the device comprises night vision goggles having two identical goggles bodies placed in front of the observer's eyes. Each body essentially comprises a focusing objective 56, an amplifier device 55 and an eyepiece 57. The operation of this assembly is well known and will not be explained in detail in this description. As indicated in FIG. 4, the night vision goggles are cantilevered and held in place by a fastening system 6 on the top of the helmet. This system generally includes a mechanism for adjusting the interpupillary distance between the bodies of goggles.

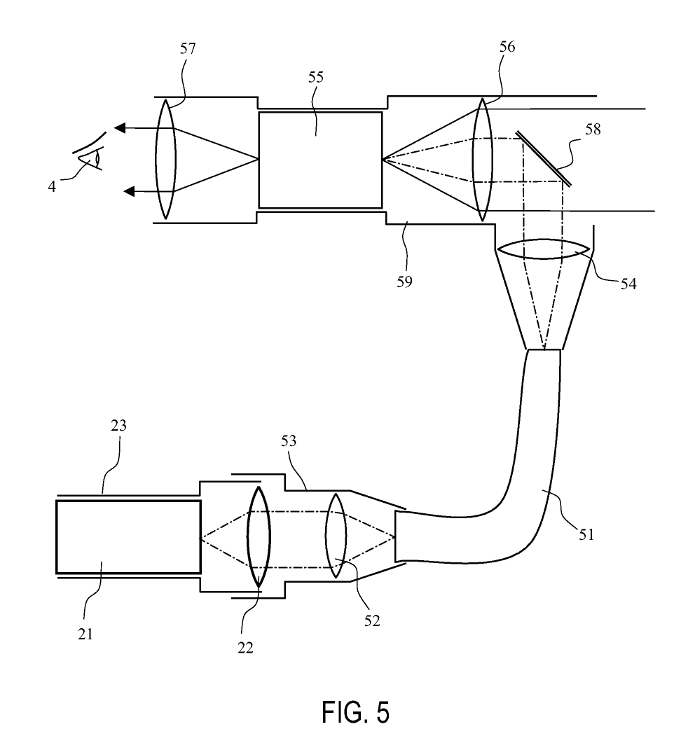

The image output by the generator 2 is mixed with the image of the external scene by means of the device shown in detail in FIG. 5 and given by way of example.

The device in FIG. 5 essentially comprises:

an optical-fibre image transporter comprising an optical-fibre guide 51 and two focusing optics 52 and 54 placed at each end of the fibre guide;

a semi-reflecting optic 58 placed between the image transporter and the focusing objective 56 of the first goggles body; and

mechanical means 53 for coupling to the image generator and mechanical means 59 for connection to the bodies of night vision goggles.

The path of the light rays coming from the image generator is indicated by the dotted arrows in FIG. 5. The collimated rays coming from the optical collimation device 22 are focused by means of the focusing optic 52 onto the entrance of the optical-fibre guide 51. The latter must have a sufficient number of fibres to obtain the desired resolution. It must also be flexible enough to allow the goggles body to be adjusted in front of the user's eyes. This type of optical-fibre guide is used in particular in endoscopy. The image transmitted via the fibre guide is collimated by the optic 54 and mixed with the external scene, before the objective 56, by means of the semi-reflecting plate 58.

One of the advantages of this first embodiment is that the image generator has just one position, common to both display modules. Thus the generator may be permanently mounted on the helmet. However, the use of an optical-fibre image transporter necessarily increases the weight supported by the helmet and degrades the quality of the final image.

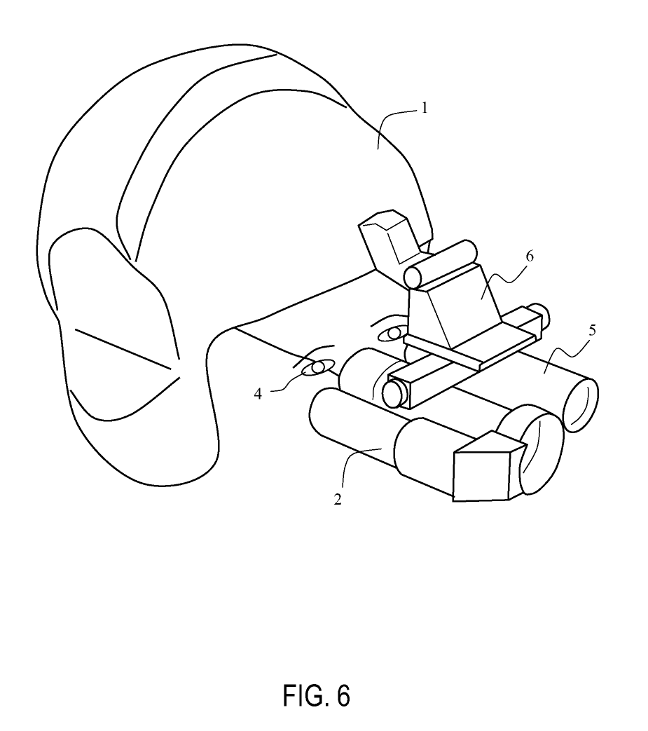

FIG. 6 shows the same support helmet with a second embodiment of a second, night-time display module. In this embodiment, the optical-fibre image transporter is omitted. The image generator is connected directly to the optomechanical device 5.

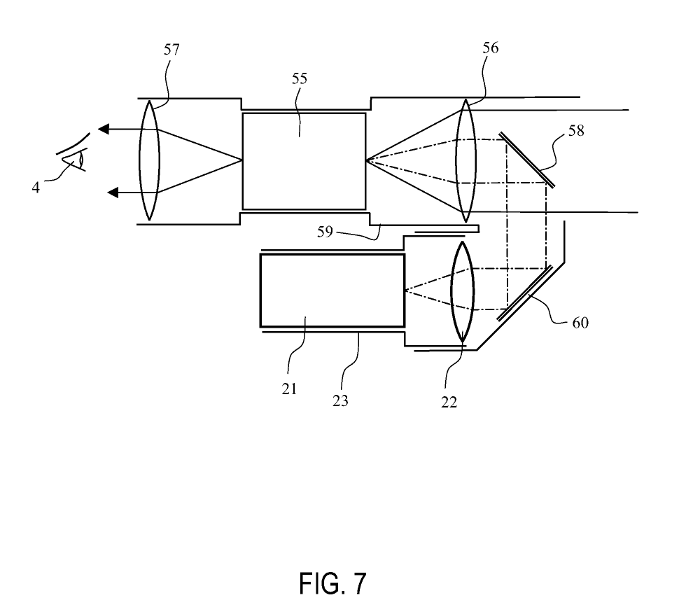

The path of the light rays coming from the image generator is indicated by the dotted lines in FIG. 7. The collimated rays coming from the optical collimation device 22 are mixed with the external scene, before the objective 56, by means of the semi-reflecting plate 58. One or more folding mirrors 60 fold the optical beams so as to reduce the overall size of the system.

The semi-reflecting plate 58 may be replaced with more complex optical devices, for example to provide pupil matching between the optical device comprising the image generator and the pupil of the objective 56. This device may for example be an optical mixer formed from two optical components joined together via a substantially plane common face, having the general shape of a plate with plane parallel faces, said common face being inclined at about 45 degrees to said plane faces; said plate having an entrance face and an opposite face substantially perpendicular to said plane faces; and the opposite face having substantially the shape of a reflecting spherical dioptric surface.

In general, the surface for mixing the image output by the generator with the external scene has a slightly reflective treatment insofar as it is necessary both at the same time to reduce the luminance of the electronic image, in order to make it compatible with low night-time illumination levels, while still maintaining the best possible transmission to the outside.

What is claimed is:

1. A modular helmet-mounted display assembly, comprising:
a support helmet to be worn by a user;
an image generator to be mounted on said helmet;
a first optomechanical device having a first collimation/superposition means for collimating the images output by the image generator and for superposing them on the external scene; and
a second optomechanical device having a second collimation/superposition means for collimating the images output by the image generator and for superposing the collimated images on the external scene, and means for amplifying the external scene and said collimated images, wherein:
the image generator and the first and second optomechanical devices including complementary optomechanical coupling means either for fastening the image generator to the first optomechanical device, so as to produce a first display module, or for fastening the image generator to the second optomechanical device, so as to produce a second display module; and
the first and second modules also including mechanical coupling means for fastening said modules to the helmet and for disconnecting said modules therefrom.

2. The display system according to claim 1, wherein the image generator includes an image display and an optical collimation device placed in front of the display and forming, from the image provided by this display, a collimated image.

3. The display system according to claim 1, wherein the image generator is placed on a lateral part of the support helmet.

4. The display system according to claim 1, wherein the first optomechanical device includes a transparent plate having substantially plane and mutually parallel faces, said plate comprising a reflecting first curved mirror and a semi-reflecting second curved mirror which are placed so as to obtain an a focal optical device.

5. The display system according to claim 1, wherein the amplifying means of the second device comprise a first goggles body, said first body including a focusing objective, an amplifier device and an eyepiece.

6. The display system according to claim 5, wherein the second optical collimation/superposition means for collimating the images output by the image generator and for superposing the collimated images on the external scene comprising:
an optical-fiber image transporter having an optical-fiber guide and two focusing optics placed at each end of the fiber guide; and
a semi-reflecting optic placed between the image transporter and the focusing objective of the first goggles body.

7. The display system according to claim 5, wherein the second optical collimation/superposition means for collimating the images output by the image generator and for superposing the collimated images on the external scene comprise a semi-reflecting optic placed between the image generator and the focusing objective of the first goggles body.
